(19) United States
(12) Patent Application Publication
(10) Pub. No.: US 2023/0297043 A1
(43) Pub. Date: Sep. 21, 2023

(54) GENERATING SCENARIOS BY MODIFYING VALUES OF MACHINE LEARNING FEATURES

(71) Applicant: DataRobot, Inc., Boston, MA (US)

(72) Inventors: Ina Ko, Old Bridge, NJ (US); Borys Kupar, Munich (DE); Yulia Bezhula, Kyiv (UA)

(73) Assignee: DataRobot, Inc., Boston, MA (US)

(21) Appl. No.: 17/694,993

(22) Filed: Mar. 15, 2022

(51) Int. Cl. G05B 13/04; G06F 3/0482

(52) U.S. Cl. CPC G05B 13/042; G05B 13/048; G06F 3/0482

(57) ABSTRACT

A system to generate scenarios by modifying values of machine learning features is provided. The system can present a first indication in a first coordinate space of a first performance generated by a model trained with a plurality of features using machine learning. The system can present a second indication in a second coordinate space of a first performance of the first feature. The system can receive a modification to a value in the second coordinate space of the first feature. The system can determine a second performance of the model using machine learning based on a first derived feature to output derived data points in the time period. The system can present in the first coordinate space, a third indication of the second performance of the model overlaid with the first indication of the first performance of the model.

### TECHNICAL FIELD

The present implementations relate generally to machine learning models, and more particularly to generating scenarios by modifying values of machine learning features.

### BACKGROUND

Understanding future behavior of complex systems is increasingly important to effective modeling of multivariate simulation systems, for example. Understanding future behavior of systems at higher level is granularity is thus desired. However, it can be challenging to efficiently and effectively provide accurate visualization of alternative behavior that may illuminate actual historical and future behavior of a model over time. Thus, an ability to provide and enable insight into behavior of systems over time based on variations in historical data is desired. A lack of support for alternative behavior significantly reduces efficiency of understanding future behavior, and reduces effectiveness of understanding future behavior of a system.

### SUMMARY

System and methods of this technical solution can generate multiple scenarios based on a particular model and particular values input to the model. The scenarios can include a base scenario and one or more alternative, hypothetical, modified, or “what-if” scenarios. The base scenario and the what-if scenarios can each indicate a performance over time of a model, based on the particular features and values input to the model. A base scenario can correspond to a performance of a model associated with historical or measured values, for example. A what-if scenario can correspond to a performance of a model associated with hypothetical or arbitrary values. Thus, this technical solution can generate a what-if scenario from a base scenario, to indicate a what-if performance that may differ from a base performance in response to modification of values of the base scenario. Thus, present implementations can advantageously generate and present what-if scenarios to drive insight into machine learning model performance over time in view of particular data points input to those machine learning models. The technical solution can further advantageously provide a graphical user interface to receive input from a user to modify values of a feature, by interaction with one or more performances of features making up the model. It can be difficult to provide the computational processing capability and system architecture at least to present performances of particular features in a graphical user interface, to efficiently receive modifications to values associated with particular features by a graphical user interface, and to rapidly generate what-if performance models based on particular modified values of particular features. Thus, a technological solution for generating what-if scenarios by modifying values of machine learning features is provided.

An aspect of this technical solution is directed to a system. The system can include a data processing system including one or more processors, coupled to memory. The data processing system can present, via a user interface, a first indication in a first coordinate space of a first performance generated by a model trained with a plurality of features using machine learning to output a plurality of data points having corresponding time stamps in a time period. The data processing system can receive, via the user interface, a selection of a first feature of the plurality of features. The data processing system can present, via the user interface, a second indication in a second coordinate space of a first performance of the first feature, the second indication having corresponding time stamps in the time period. The data processing system can receive, via the user interface, a modification to a value in the second coordinate space of the first feature of the plurality of features. The data processing system can generate, responsive to the modification in the second coordinate space, a first derived feature based on the modified value of the first feature. The data processing system can determine a second performance of the model using machine learning based on the first derived feature to output derived data points having corresponding time stamps in the time period. The data processing system can present, via the user interface in the first coordinate space, a third indication of the second performance of the model overlaid with the first indication of the first performance of the model.

The system can determine whether one or more of the features are editable, and present, in response to a determination that the features are editable, via the user interface, a control affordance corresponding to the features, where the selection is received in response to user input at the control affordance.

The system can include a control affordance with a menu including an item identifying the first feature.

The system can present, via the user interface, a first region in the second coordinate space, the first region bounded by a first time stamp in the time period and a second time stamp later than the first time stamp in the time period.

The first region can restrict editing of the data points of the first feature to data points having corresponding time stamps in the first region.

The system can present, via the user interface, a fourth indication in a third coordinate space, the fourth indication corresponding to a first performance of a second feature and including one or more data points having corresponding time stamps in the time period.

The system can generate the third indication with input including the first derived feature and a second derived feature to output the derived points, the second derived feature corresponding to a second performance of the second feature and including one or more data points having corresponding time stamps in the time period.

The system can receive, via the user interface, a selection of the second feature among the features. The system can receive, via the user interface, a modification to a second value in the third coordinate space of the second feature. The system can generate, responsive to the modification in the third coordinate space, the second derived feature based on the modified value of the second feature.

The system can present, via the user interface, the second coordinate space and the fourth coordinate space concurrently in a graphical user interface presentation.

An aspect of this technical solution is directed to a method. The method can include presenting, via a user interface, a first indication in a first coordinate space of a first performance generated by a model trained with a plurality of features using machine learning to output a plurality of data points having corresponding time stamps in a time period. The method can include receiving, via the user interface, a selection of a first feature of the plurality of features. The method can include presenting, via the user interface, a second indication in a second coordinate space of a first performance of the first feature, the second indication having corresponding time stamps in the time period, receiving, via the user interface, a modification to a value in the second coordinate space of the first feature of the plurality of features. The method can include generating, responsive to the modification in the second coordinate space, a first derived feature based on the modified value of the first feature. The method can include determining a second performance of the model using machine learning based on the first derived feature to output derived data points having corresponding time stamps in the time period. The method can include presenting, via the user interface in the first coordinate space, a third indication of the second performance of the model overlaid with the first indication of the first performance of the model.

The method can include determining whether one or more of the features are editable. The method can include presenting, in response to a determination that the features are editable, via the user interface, a control affordance corresponding to the features. The selection can be received in response to user input at the control affordance.

The method can include a control affordance with a menu including an item identifying the first feature.

The method can include presenting, via the user interface, a first region in the second coordinate space, the first region bounded by a first time stamp in the time period and a second time stamp later than the first time stamp in the time period.

The method can include the first region restricting editing of the data points of the first feature to data points having corresponding time stamps in the first region.

The method can include presenting, via the user interface, a fourth indication in a third coordinate space, the fourth indication corresponding to a first performance of a second feature and including one or more data points having corresponding time stamps in the time period.

The method can include generating the third indication with input including the first derived feature and a second derived feature to output the derived points, the second derived feature corresponding to a second performance of the second feature and including one or more data points having corresponding time stamps in the time period.

The method can include receiving, via the user interface, a selection of the second feature among the features. The method can include receiving, via the user interface, a modification to a second value in the third coordinate space of the second feature. The method can include generating, responsive to the modification in the third coordinate space, the second derived feature based on the modified value of the second feature.

The method can include presenting, via the user interface, the second coordinate space and the fourth coordinate space concurrently in a graphical user interface presentation.

An aspect of this technical solution is directed to a computer readable medium. The computer readable medium can include one or more instructions stored thereon and executable by a processor. The processor can present, via a user interface, a first indication in a first coordinate space of a first performance generated by a model trained with a plurality of features using machine learning to output a plurality of data points having corresponding time stamps in a time period. The processor can receive, via the user interface, a selection of a first feature of the plurality of features. The processor can present, via the user interface, a second indication in a second coordinate space of a first performance of the first feature, the second indication having corresponding time stamps in the time period. The processor can receive, via the user interface, a modification to a value in the second coordinate space of the first feature of the plurality of features. The processor can generate, responsive to the modification in the second coordinate space, a first derived feature based on the modified value of the first feature. The processor can determine a second performance of the model using machine learning based on the first derived feature to output derived data points having corresponding time stamps in the time period. The processor can present, via the user interface in the first coordinate space, a third indication of the second performance of the model overlaid with the first indication of the first performance of the model.

The processor can present, via the user interface, a fourth indication in a third coordinate space, the fourth indication corresponding to a first performance of a second feature and including one or more data points having corresponding time stamps in the time period.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a user interface presentation of overlaid performance projections over time, in accordance with present implementations.

FIG. 2 illustrates a system in accordance with present implementations.

FIG. 3 illustrates a system architecture in accordance with present implementations.

FIG. 4 illustrates a user interface presentation of selection of features associated with a model generated using machine learning, in accordance with present implementations.

FIG. 5 illustrates a user interface presentation of a first performance projection over time, in accordance with present implementations.

FIG. 6A illustrates a first state of a user interface presentation to modify features of a model, in accordance with present implementations.

FIG. 6B illustrates a second state of a user interface presentation to modify features of a model, further to the state of FIG. 6A.

FIG. 6C illustrates a third state of a user interface presentation to modify features of a model, further to the state of FIG. 6B.

FIG. 6D illustrates a fourth state of a user interface presentation to modify features of a model, further to the state of FIG. 6C.

FIG. 7 illustrates a further user interface presentation of overlaid performance projections over time, in accordance with present implementations.

FIG. 8 illustrates a method of modifying a projection based on one more modified values of particular features in a model, in accordance with present implementations.

FIG. 9 illustrates a method of modifying a projection based on one more modified values of particular features in a model, further to the method of FIG. 8.

FIG. 10 illustrates a method of modifying a projection based on one more modified values of particular features in a model, further to the method of FIG. 9.

FIG. 11 illustrates a method of modifying a projection based on one more modified values of particular features in a model, further to the method of FIG. 10.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Present implementations can advantageously receive user input to modify particular data points of particular features of a machine learning model, and can generate various performance curves of the model based on the modified values. As one example, present implementations can include a graphical user interface to present performances of multiple features of a model, where the performances include plots of values of the features at particular time stamps. The time stamps can have any granularity appropriate for the model, feature, or presentation. Present implementations can include an interactive graphical user interface in which a user can modify one or more data points of one or more performances of one or more features, to result in a modified values and modified performances over time of those features. A modification of a point can indicate a hypothetical situation at a particular point. As one example, a point can be modified to have a larger value, to indicate hypothetical higher prices for a particular commodity on a particular day. A user can thus modify multiple values of multiple features by a graphical user interface to rapidly generate hypothetical scenarios that can be provided as input to a model using machine learning. The model can then generate a what-if performance over time to indicate, for example, a sales forecast over time based on the hypothetical values for various features. Present implementations are thus directed at least to a technical solution of a particular graphical user interface to rapidly modify values of a feature on a feature-by-feature basis in accordance with a particular scenario.

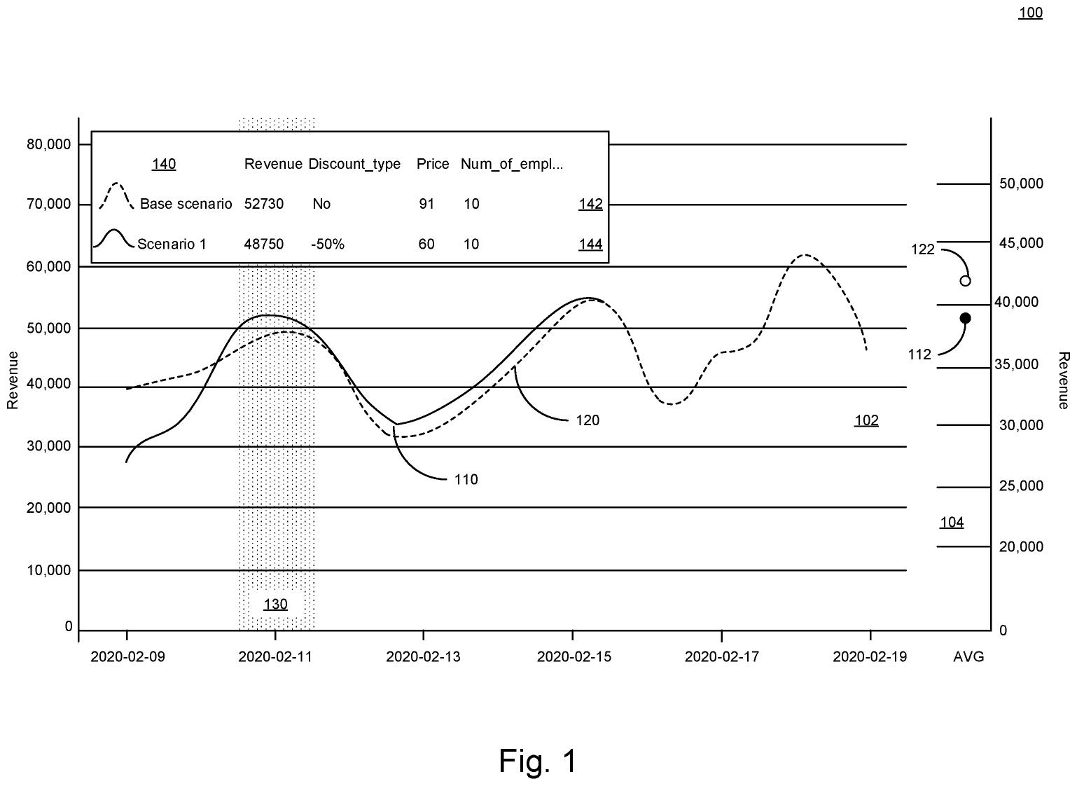

FIG. 1 illustrates a user interface presentation of overlaid performance projections over time, in accordance with present implementations. As illustrated by way of example in FIG. 1, an example presentation 100 can include a first presentation area 102 and a second presentation area 104. The first presentation area 102 can include a first performance 110, a second performance 120, a highlight area 130, and a metric presentation region 140. The second presentation area can include a first metric 112 associated with the first performance 110, and a second metric associated with the second performance 120.

As one example, the presentation 100 can indicate an actual performance of expected temperature of a home over a time period, in view of actual historical data organized as features including energy usage, occupancy, seasonal outdoor temperatures. In this example, a user can modify one or more data points associated with energy usage, to indicate a hypothetical situation in which less energy is used during particular days or times. The user can also modify one or more data points associated with seasonal outdoor temperatures, to indicate a hypothetical situation in which a heat wave occurs during particular days or times. The system can then generate a hypothetical performance of expected temperature over the same time period, under the hypothetical features driven by the modification at the user interface. Both of the actual performance and the hypothetical performance can be overlaid in the same presentation area of the user interface to easily indicate portions of the hypothetical performance that deviates from the actual performance.

The first performance 110 can correspond to a behavior of a model over time with respect to one or more input features and values associated with those input features. The first and second performances 110 and 120 can be generated based on execution of a model trained by the features associated with that model and values associated with various features. The second performance 120 can correspond to a behavior of a model over time with respect to one or more input features having values modified from the values of the features of the first performance 110. A model can generate both the first and second performances based on various modified and unmodified features including modified and unmodified values.

The highlight area 130 can indicate, via a user interface, a portion of one or more of the first performance 110 and the second performance 120 associated with metrics of the metric presentation region 140. The highlight area 130 can have a color, pattern, or the like, for example, that can distinguish the highlight area 130 from the surrounding first presentation area 102. The metric presentation region 140 can include one or more metrics associated with one or more of the first performance 110 and the second performance 120. The metric presentation region 140 can include metrics 142 associated with the first performance 110 and metrics 144 associated with the second performance 120. It is to be understood that metrics presented in the metric presentation region 140 are not limited to the metrics presented herein by way of example.

The first metric 112 and the second metric 122 can represent values associated respectively with the first and second performances 110 and 120. As one example, the first metric 112 and the second metric 122 can represent respective averages of output values or feature values of the first and second performances 110 and 120 over a time period.

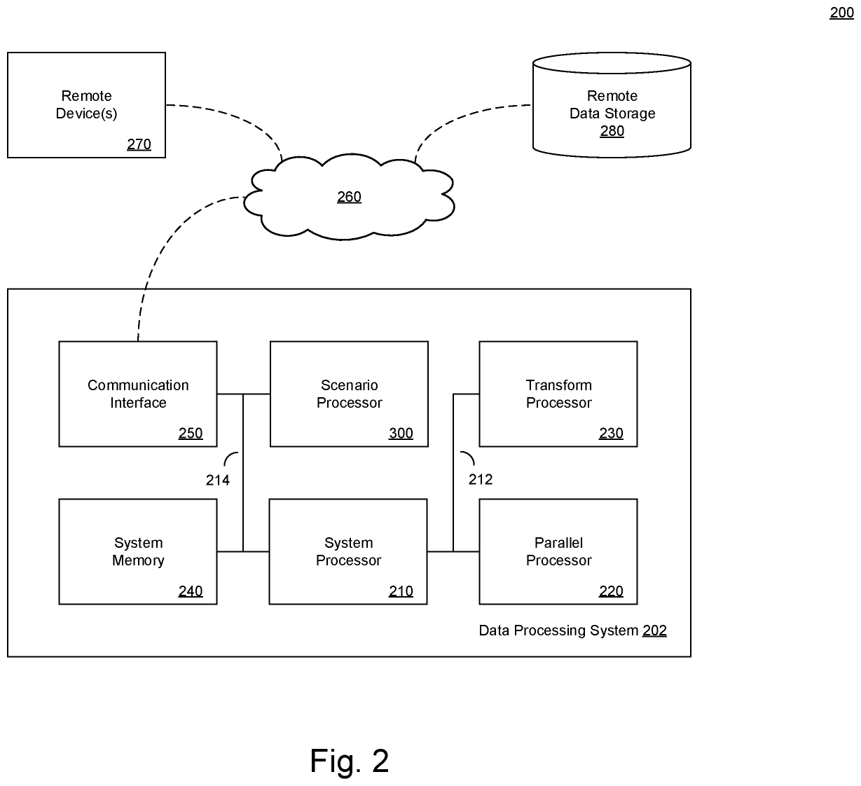

FIG. 2 illustrates a system in accordance with present implementations. As illustrated by way of example in FIG. 2, an example processing system 200 includes a data processing system 202, a network 260, one or more remote devices 270, and one or more remote data storage devices 280. The data processing system includes a system processor 210, a parallel processor 220, a transform processor 230, a system memory 240, a communication interface 250, and a scenario processor 300. At least one of the example processing system 200 or the system processor 210 can include a processor bus 212 and a system bus 214.

The data processing system 202 can receive and/or transmit data via the network 260 with one or more of the remote devices 270 or one or more of the remote data storage devices 280. The data processing system 202 can include an architecture including, for example, a client-server architecture in which presentation, application processing, and data management functions are logically or physically separated. The data processing system 202 can serve static content or dynamic content to be rendered by one or more of the remote devices 270, and can process instructions and data to provide data to and receive data from the remote devices 270 and the remote data storage devices 280.

The system processor 210 can execute one or more instructions. The instructions can be associated with at least one of the system memory 240 or the communication interface 250. The system processor 210 can include an electronic processor, an integrated circuit, or the like including one or more of digital logic, analog logic, digital sensors, analog sensors, communication buses, volatile memory, nonvolatile memory, and the like. The system processor 210 can include but is not limited to, at least one microcontroller unit (MCU), microprocessor unit (MPU), central processing unit (CPU), graphics processing unit (GPU), physics processing unit (PPU), embedded controller (EC), or the like. In some implementations, the system processor 210 can include a memory operable to store or storing one or more instructions for operating components of the system processor 210 and operating components operably coupled to the system processor 210. The one or more instructions can include at least one of firmware, software, hardware, operating systems, embedded operating systems, or the like.

The processor bus 212 can communicate one or more instructions, signals, conditions, states, or the like between one or more of the system processor 210, the parallel processor 220, and the transform processor 230. The processor bus 212 can include one or more digital, analog, or like communication channels, lines, traces, or the like. It is to be understood that any electrical, electronic, or like devices, or components associated with the system bus 214 can also be associated with, integrated with, integrable with, supplemented by, complemented by, or the like, the system processor 210 or any component thereof.

The system bus 214 can communicate one or more instructions, signals, conditions, states, or the like between one or more of the system processor 210, the system memory 240, and the communication interface 250. The system bus 214 can include one or more digital, analog, or like communication channels, lines, traces, or the like. It is to be understood that any electrical, electronic, or like devices, or components associated with the system bus 214 can also be associated with, integrated with, integrable with, supplemented by, complemented by, or the like, the system processor 210 or any component thereof.

The parallel processor 220 can execute one or more instructions concurrently, simultaneously, or the like. The parallel processor 220 can execute one or more instructions in a parallelized order in accordance with one or more parallelized instruction parameters. Parallelized instruction parameters can include one or more sets, groups, ranges, types, or the like, associated with various instructions. The parallel processor 220 can include one or more execution cores variously associated with various instructions. The parallel processor 220 can include one or more execution cores variously associated with various instruction types or the like. The parallel processor 220 can include an electronic processor, an integrated circuit, or the like including one or more of digital logic, analog logic, communication buses, volatile memory, nonvolatile memory, and the like. The parallel processor 220 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the parallel processor 220 can also be associated with, integrated with, integrable with, supplemented by, complemented by, or the like, the system processor 210 or any component thereof.

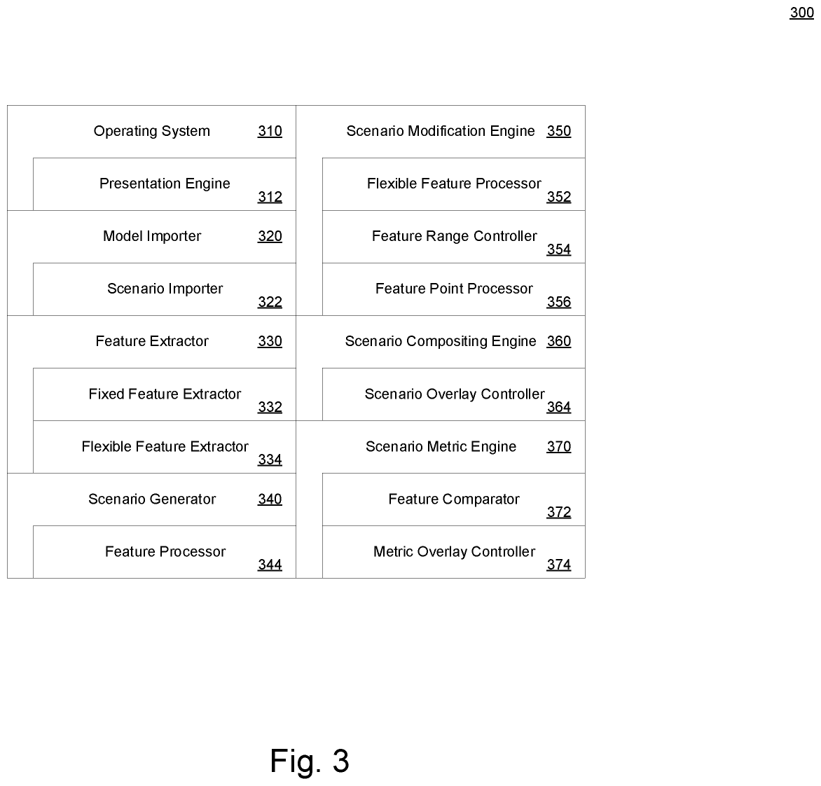

Various cores of the parallel processor 220 can be associated with one or more parallelizable operations in accordance with one or more metrics, engines, models, and the like, of the example computing system of FIG. 3. As one example, parallelizable operations include processing portions of an image, video, waveform, audio waveform, processor thread, one or more layers of a learning model, one or more metrics of a learning model, one or more models of a learning system, and the like. A predetermined number or predetermined set of one or more particular cores of the parallel processor 220 can be associated exclusively with one or more distinct sets of corresponding metrics, engines, models, and the like, of the example computing system of FIG. 3. As one example, a first core of the parallel processor 220 can be assigned to, associated with, configured to, fabricated to, or the like, execute one engine of the computing system of FIG. 3. In this example, a second core of the parallel processor 220 can also be assigned to, associated with, configured to, fabricated to, or the like, execute another engine of the computing system of FIG. 3. Thus, the parallel processor 220 can parallelize execution across one or more metrics, engines, models, and the like, of the computing system of FIG. 3. Similarly, a predetermined number or predetermined set of one or more particular cores of the parallel processor 220 can be associated collectively with corresponding metrics, engines, models, and the like, of the computing system of FIG. 3. As one example, a first plurality of cores of the parallel processor can be assigned to, associated with, configured to, fabricated to, or the like, execute one engine of the computing system of FIG. 3. In this example, a second plurality of cores of the parallel processor can also be assigned to, associated with, configured to, fabricated to, or the like, execute another engine of the computing system of FIG. 3. Thus, the parallel processor 220 can parallelize execution within one or more metrics, engines, models, and the like, of the computing system of FIG. 3.

The transform processor 230 can execute one or more instructions associated with one or more predetermined transformation processes. As one example, transformation processes include Fourier transforms, matrix operations, calculus operations, combinatoric operations, trigonometric operations, geometric operations, encoding operations, decoding operations, compression operations, decompression operations, image processing operations, audio processing operations, and the like. The transform processor 230 can execute one or more transformation processes in accordance with one or more transformation instruction parameters. Transformation instruction parameters can include one or more instructions associating the transform processor 230 with one or more predetermined transformation processes. The transform processor 230 can include one or more transformation processes. The transform processor 230 can include a plurality of transform processors 230 variously associated with various predetermined transformation processes. The transform processor 230 can include a plurality of transformation processing cores each associated with, configured to execute, fabricated to execute, or the like, a predetermined transformation process. The transform processor 230 can include an electronic processor, an integrated circuit, or the like including one or more of digital logic, analog logic, communication buses, volatile memory, nonvolatile memory, and the like. The transform processor 230 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the transform processor 230 can also be associated with, integrated with, integrable with, supplemented by, complemented by, or the like, the system processor 210 or any component thereof.

The transform processor 230 can be associated with one or more predetermined transform processes in accordance with one or more metrics, engines, models, and the like, of the computing system of FIG. 3. A predetermined transform process of the transform processor 230 can be associated with one or more corresponding metrics, engines, models, and the like, of the computing system of FIG. 3. As one example, the transform processor 230 can be assigned to, associated with, configured to, fabricated to, or the like, execute one matrix operation associated with one or more engines, metrics, models, or the like, of the computing system of FIG. 3. As another example, the transform processor 230 can alternatively be assigned to, associated with, configured to, fabricated to, or the like, execute another matrix operation associated with one or more engines, metrics, models, or the like, of the example computing system of FIG. 3. Thus, the transform processor 230 can centralize, optimize, coordinate, or the like, execution of a transform process across one or more metrics, engines, models, and the like, of the example computing system of FIG. 3. In some implementations, the transform processor is fabricated to, configured to, or the like, execute a particular transform process with at least one of a minimum physical logic footprint, logic complexity, heat expenditure, heat generation, power consumption, or the like, with respect to one or more metrics, engines, models, and the like, of the example computing system of FIG. 3.

The system memory 240 can store data associated with the example system 200. The system memory 240 can include one or more hardware memory devices for storing binary data, digital data, or the like. The system memory 240 include one or more electrical components, electronic components, programmable electronic components, reprogrammable electronic components, integrated circuits, semiconductor devices, flip flops, arithmetic units, or the like. The system memory 240 can include at least one of a non-volatile memory device, a solid-state memory device, a flash memory device, or a NAND memory device. The system memory 240 can include one or more addressable memory regions disposed on one or more physical memory arrays. As one example, a physical memory array can include a NAND gate array disposed on a particular semiconductor device, integrated circuit device, or printed circuit board device.

The communication interface 250 can communicatively couple the system processor 210 to an external device. An external device includes but is not limited to a smartphone, mobile device, wearable mobile device, tablet computer, desktop computer, laptop computer, cloud server, local server, and the like. The communication interface 250 can communicate one or more instructions, signals, conditions, states, or the like between one or more of the system processor 210 and the external device. The communication interface 250 includes one or more digital, analog, or like communication channels, lines, traces, or the like. As one example, the communication interface 250 can include at least one serial or parallel communication line among multiple communication lines of a communication interface. The communication interface 250 can include one or more wireless communication devices, systems, protocols, interfaces, or the like. The communication interface 250 can include one or more logical or electronic devices including but not limited to integrated circuits, logic gates, flip flops, gate arrays, programmable gate arrays, and the like. The communication interface 250 can include one or more telecommunication devices including but not limited to antennas, transceivers, packetizers, wired interface ports, and the like. It is to be understood that any electrical, electronic, or like devices, or components associated with the communication interface 250 can also be associated with, integrated with, integrable with, replaced by, supplemented by, complemented by, or the like, the system processor 210 or any component thereof.

The scenario processor 300 can execute one or more instructions associated with the system architecture of FIG. 3. The scenario processor 300 can include an electronic processor, an integrated circuit, or the like including one or more of digital logic, analog logic, communication buses, volatile memory, nonvolatile memory, and the like, operable to implement the architecture of FIG. 3.

The network 260 can include an electronic communication system. The geographical scope of the network 260 can include a body area network (BAN), a personal area network (PAN), a local-area network (LAN), e.g. Intranet, a metropolitan area network (MAN), a wide area network (WAN), or the Internet. The network 260 can include a broadcast network, a telecommunications network, a data communication network, or a computer network. The network 260 can include a network or subnetwork implementing a cloud. The cloud can be public, private, or hybrid. Public clouds can include public servers maintained by third parties distinct from the owners of the remote devices 270. Public clouds can be connected to the data processing system 202 over a public network. Private clouds can include private servers physically maintained by owners of the remote devices 270. Private clouds can be connected to the data processing system 202 over a private network. Hybrid clouds can include both the private and public networks. It is to be understood that the data processing system 202 can be connected with the network 260 by the communication interface 250. The cloud can also include, for example, a Software as a Service (SaaS) system, Platform as a Service (PaaS) system, or Infrastructure as a Service (IaaS) system.

The remote devices 270 can include, e.g., thick clients, thin clients, and zero clients. A thick client can provide at least some functionality even when disconnected from the network 260. Functionality of a thin client or a zero client can depend on the connection to the network 260 or. A zero client can depend on the network 260 to retrieve operating system data for the remote device. As one example, the remote devices 270 can include embedded computing devices, personal computing devices, mobile computing devices, and the like.

The remote data storage devices 280 can store data associated with and external to the example system 200. The remote data storage devices 280 can include one or more hardware memory devices for storing binary data, digital data, or the like. The remote data storage devices 280 can include one or more electrical components, electronic components, programmable electronic components, reprogrammable electronic components, integrated circuits, semiconductor devices, flip flops, arithmetic units, or the like, integrated intwo, or housed within, for example, an electronic computer or server. The remote data storage devices 280 can include at least one of a non-volatile memory device, a solid-state memory device, a flash memory device, or a NAND memory device, arranged in a database structure.

FIG. 3 illustrates a system architecture in accordance with present implementations. As illustrated by way of example in FIG. 3, scenario processor 300 can include an operating system 310, a model importer 320, a feature extractor 330, a scenario generator 340, a scenario modification engine 350, a scenario compositing engine 360, and a scenario metric engine 370. The system architecture can, for example, comprise one or more instructions or hardware elements stored on or integrated with the system memory 240.

The operating system 310 can include hardware control instructions and program execution instructions. The operating system 310 can include a high level operating system, a server operating system, an embedded operating system, or a boot loader. The operating system 310 can include one or more instructions operable specifically with or only with the system processor 210, the parallel processor 220, or the transform processor 230. The operating system 310 can include a presentation engine 312. The presentation engine 312 can include one or more instructions to instruct a display device to present one or more graphical user interface elements. Graphical user interface elements can include, but are not limited to text, images, video charts, graphs, tables, two-dimensional models, and three-dimensional models. The display device can include an electronic display. An electronic display can include, for example, a liquid crystal display (LCD), a light-emitting diode (LED) display, an organic light-emitting diode (OLED) display, or the like.

The model importer 320 can obtain one or more models associated with a machine learning process, and can obtain those models from a local memory or a remote memory, for example. The model importer 320 can obtain models corresponding to particular features and can obtain additional metadata, for example, identifying particular features, input data sets, output data sets, and the like, for example, associated with the model. The model importer 320 can include a scenario importer 322. The scenario importer 322 can obtain one or more scenarios corresponding to a particular model. As one example, the scenario importer 322 can import one or more scenarios, including one or more base scenarios or what-if scenarios, associated with a particular model.

The feature extractor 330 can access a model obtained by the model importer 320, and can identify one or more features associated with a particular model. The feature extractor can extract fixed features, flexible features, and derived features. Fixed features can include features with values that are not editable with respect to a particular scenario. Flexible features can include features with values that are editable with respect to a particular scenario. Derived features can include features with values that have been edited with respect to a particular scenario. The feature extractor 330 can include a fixed feature extractor 332 and a flexible feature extractor 334. The fixed feature extractor 332 can identify one or more fixed features associated with the model, and can designate one or more features of the model as fixed features. As one example, the fixed feature extractor 332 can receive one or more selection via a user interface, and can designate one or more features of the model as fixed features based on the selections associated with those features. The flexible feature extractor 334 can identify one or more flexible features associated with the model, and can designate one or more features of the model as flexible features. As one example, the flexible feature extractor 334 can receive one or more selection via a user interface, and can designate one or more features of the model as flexible features based on the selections associated with those features.

The scenario generator 340 can execute model to generate a projection. The projection can be based on the model and any fixed, flexible, or derived features associated with the model. The scenario generator 340 can generate, for example, base scenarios and what-if scenarios. The scenario generator 340 can include a feature processor 344. The feature processor 344 can obtain one or more features and the values corresponding to those features. Further, the feature processor 344 can preprocess the feature input comprising the features and the values of those features into input to a model to generate a particular scenario. The preprocessing can include a preprocessing operation or operations to prepare the input values for input to a particular machine learning model.

The scenario modification engine 350 can modify one or more values of one or more features associated with a particular scenario. The scenario modification engine 350 can integrate with or communicate with, for example, the presentation engine 312 to receive user input indicating modifications to values of particular features. The scenario modification engine 350 can include a flexible feature processor 352, a feature range controller 354, and a feature point processor 356.

The flexible feature processor 352 can modify values of a flexible feature, based, for example, on input received by the presentation engine 312 via a user interface. The flexible feature processor 352 can receive modification input and can generate a derived feature based on the modification to the values. The feature range controller 354 can generate an editable region corresponding to a particular feature, and can enforce limitations on editing values of the feature based on the bounds of the editable region. The feature range controller 354 can, for example, discard or deny input to modify values of a feature outside the bounds of the editable region associated with the feature. The feature point processor 356 can modify values in response to receiving input at the flexible feature processor 352 and in response to receiving an authorization to edit or a lack of restriction on an attempt to edit a value of a particular feature, from the feature range controller 354.

The scenario compositing engine 360 can combine performances from multiple scenarios into a combined presentation. The scenario compositing engine 360 can include a scenario overlay controller 364. The scenario overlay controller 364 can graphically overlay one performance on another performance. The overlay can be within a single coordinate space, with each performance aligned to the coordinate spaces based, for example, on values of time stamps and values of features of the performances. The scenario compositing engine 360 can, for example, execute the scenario generator 340 with respect to multiple scenarios and a single coordinate space to generate each scenario, and can execute the scenario overlay controller 364 to

The scenario metric engine 370 can generate and present one or more metrics associated with one or more scenarios, including overlaid scenarios. The scenario metric engine 370 can include a feature comparator 372 and a metric overlay controller 374. The feature comparator 372 can calculate and present one or more comparative values between values of various scenarios composited by the scenario compositing engine. As one example, the feature comparator 372 can generate a difference between values of two overlaid scenarios at a particular time stamp. The metric overlay controller 374 can overlay one or more presentations calculated by the feature comparator 372 on a coordinate space or a user interface presentation associated with the overlaid scenarios. As one example, the metric overlay controller 374 can generate a pop-up window on a coordinate space including two overlaid scenarios that presents one or more comparative values generated by the feature comparator 372.

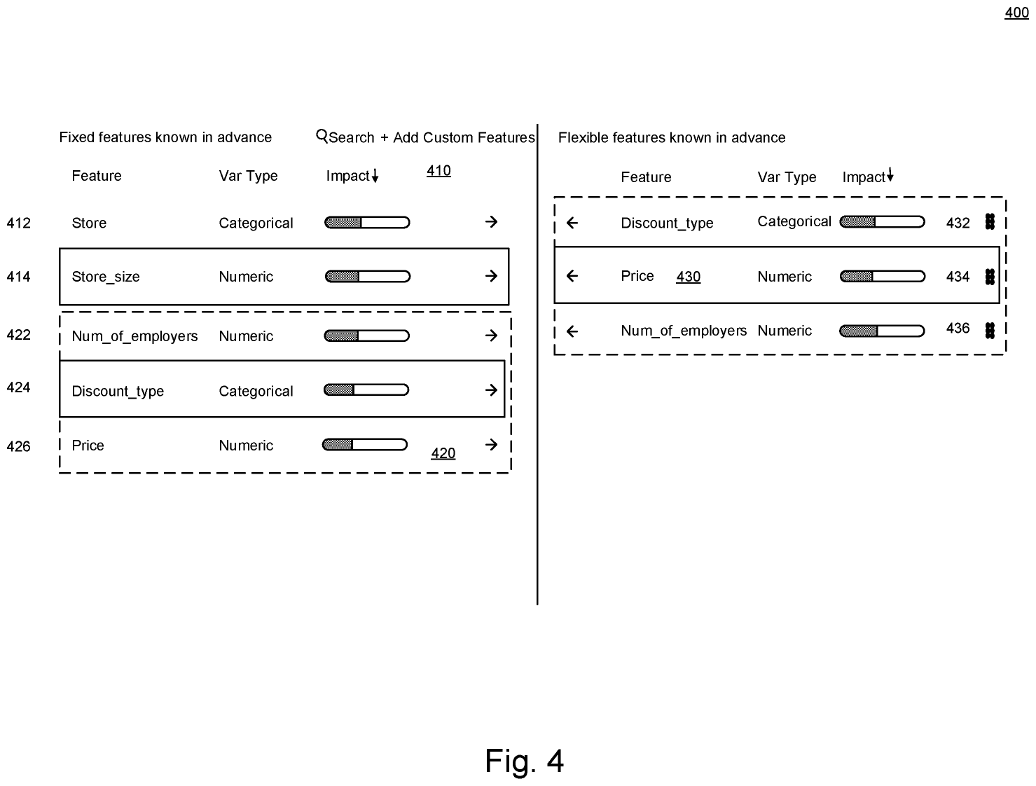

FIG. 4 illustrates a user interface presentation of selection of features associated with a model generated using machine learning, in accordance with present implementations. As illustrated by way of example in FIG. 4, an example user interface presentation 400 can include an input feature region 410 with a plurality of unselected features 412 and 414, a first position region 420 of a plurality of selected flexible features 422, 424 and 426, and a second position region 430 of a plurality of selected flexible features 432, 434 and 436. As one example, a user can select via a graphical user interface, one or more features appearing in the input feature region 410, to designate those features as flexible features. In this example, a subset of features in the input feature region 410 are selected as flexible features, and can be shifted to the second position region 430 indicating that the features are flexible features. As another example, the features can be removed from the first position region 420 and added to the second position region 430. The unselected features 412 and 414 can be designated and treated as fixed features. As one example, values of fixed features can be restricted from modification.

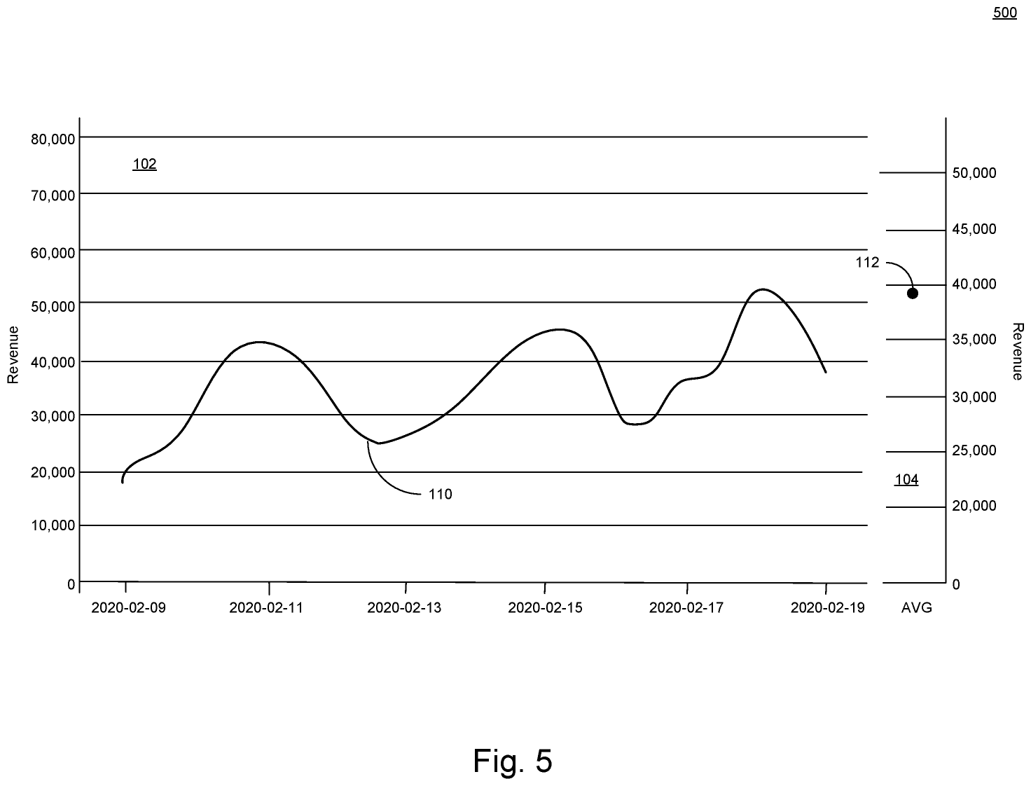

FIG. 5 illustrates a user interface presentation of a first performance projection over time, in accordance with present implementations. As illustrated by way of example in FIG. 5, an example presentation 500 can include the first presentation area 102 and the second presentation area 104, the first performance 110, and the first metric 112. The presentation 500 can represent a state including only a base scenario, and prior to presenting a what-if scenario, for example.

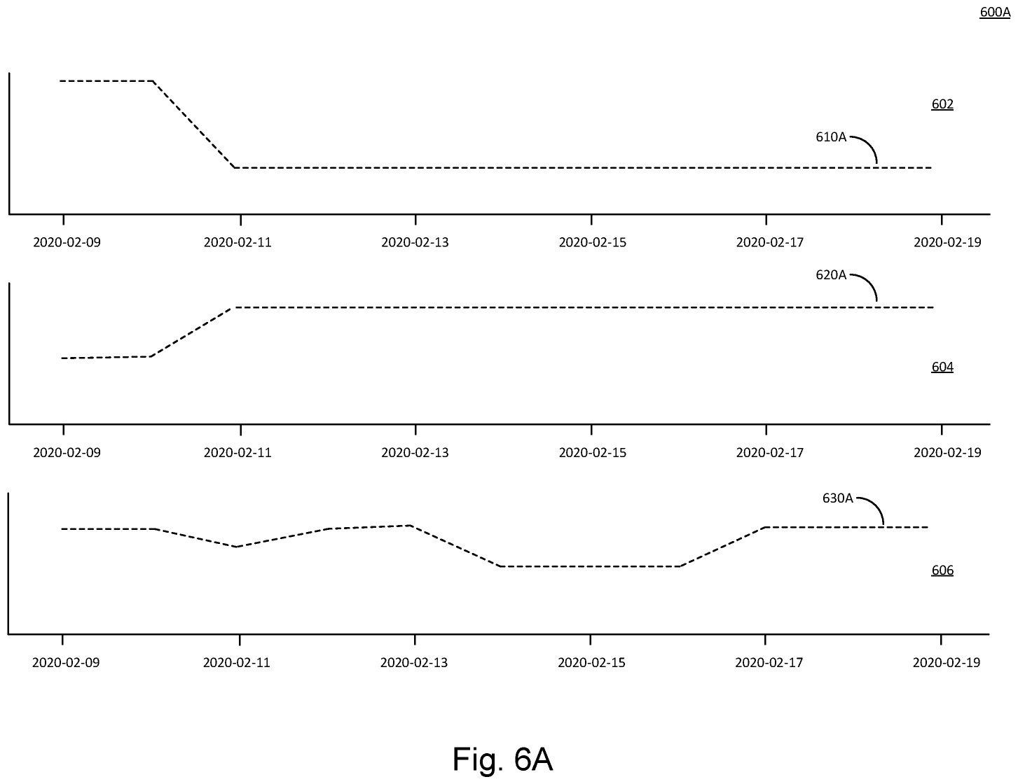

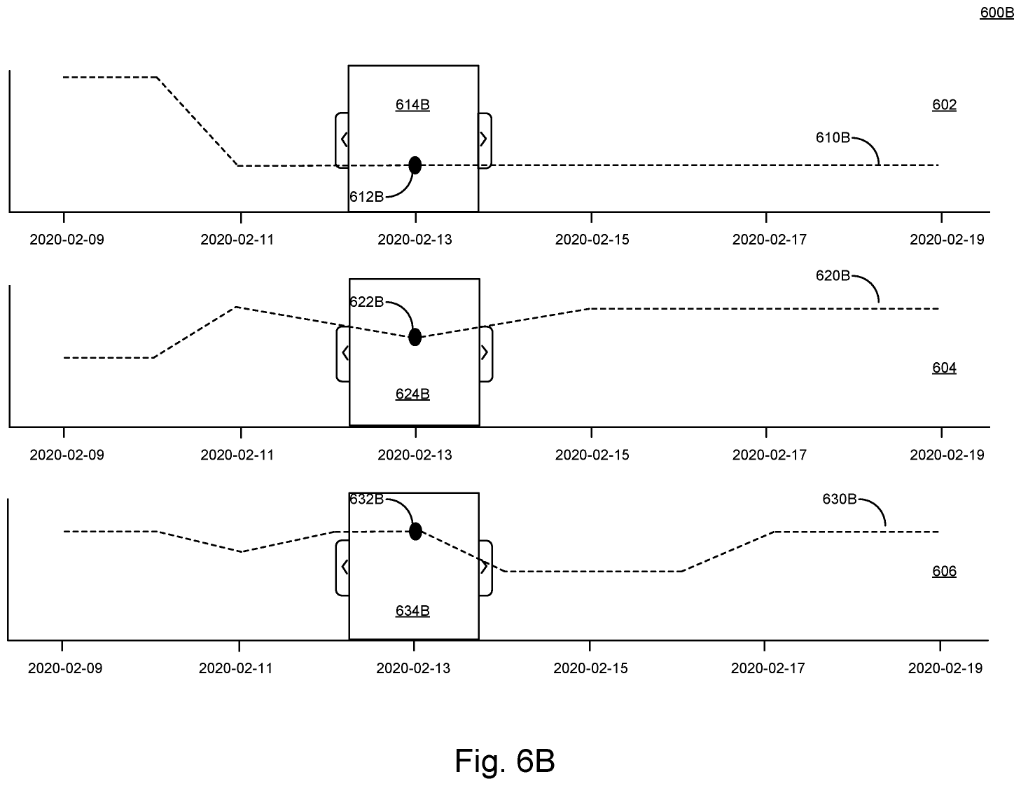

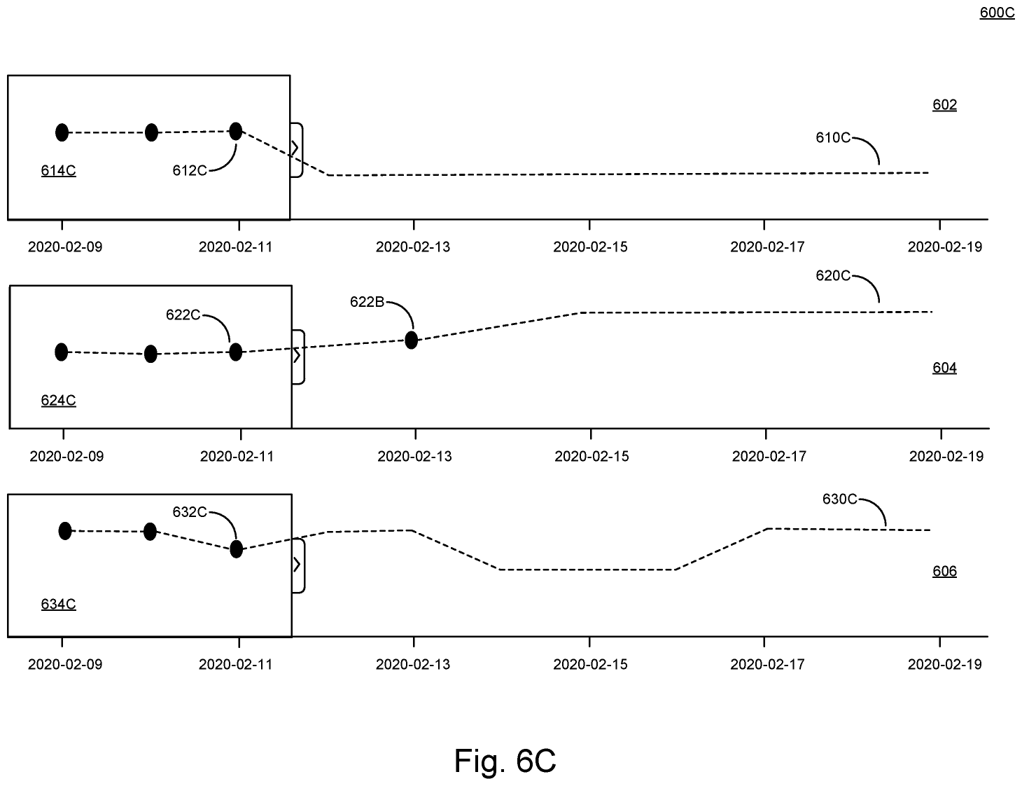

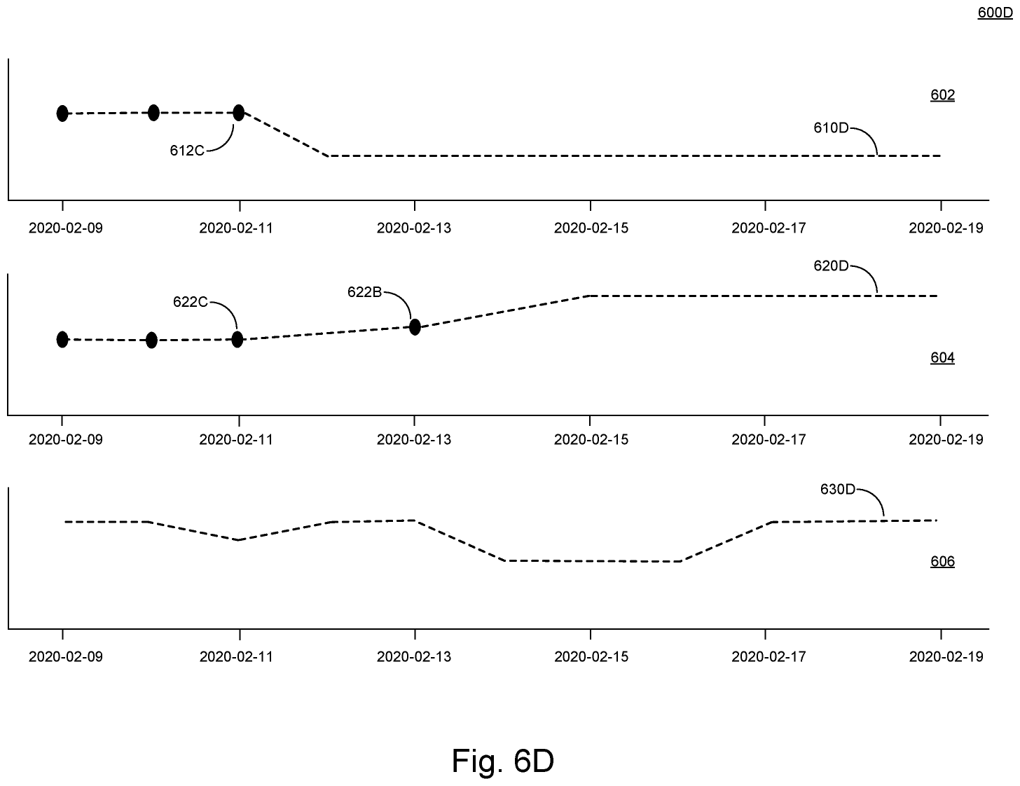

FIG. 6A illustrates a first state of a user interface presentation to modify features of a model, in accordance with present implementations. As illustrated by way of example in FIG. 6A, an example user interface presentation 600A can include a first coordinate space 602, a second coordinate space 604, and a third coordinate space 606. The first coordinate space 602 can include a first performance of a first feature 610A in a first state. The second coordinate space 604 can include a second performance of a second feature 620A in a first state. The third coordinate space 604 can include a third performance of a third feature 630A in a first state. The first state can correspond to a state of a performance of a feature corresponding to, for example, a base scenario or prior to a modification of any values of a feature via a user interface.

FIG. 6B illustrates a second state of a user interface presentation to modify features of a model, further to the state of FIG. 6A. As illustrated by way of example in FIG. 6B, an example user interface presentation 600B can include the first coordinate space 602, the second coordinate space 604, the third coordinate space 606, a first editable data point 612B in the first coordinate space 602, a first editable region 614B in the first coordinate space 602, a first editable data point 622B in the second coordinate space 604, a first editable region 624B in the second coordinate space 604, and a first editable data point 632B in the third coordinate space 606, and a first editable region 634B in the third coordinate space 606.

The first coordinate space 602 can include a second performance of a first feature 610B in a second state. The second coordinate space 604 can include a second performance of a second feature 620B in a second state. The third coordinate space 604 can include a second performance of a third feature 630B in a second state. The second state can correspond to a state of a performance of a feature corresponding to, for example, a base scenario including one or more indications of editable regions permitting modification of one or more values of a feature via a user interface. The editable regions 614B, 624B and 634B can respectively indicate portions of the first, second, and third performances 610B, 620B and 630B that are editable via the user interface, and can be bounded by earlier time stamps at left window edges and later time stamps at right window edges thereof, for example. The data points 612B, 622B and 632B can be editable via a user interface to have at least a value different than in the first state 600A.

FIG. 6C illustrates a third state of a user interface presentation to modify features of a model, further to the state of FIG. 6B. As illustrated by way of example in FIG. 6C, an example user interface presentation 600C can include the first coordinate space 602, the second coordinate space 604, the third coordinate space 606, a second set of editable data points 612C in the first coordinate space 602, a second editable region 624C in the first coordinate space 602, a second set of editable data points 622C in the second coordinate space 604, a second editable region 632C in the second coordinate space 604, a second set of editable data points 632C in the third coordinate space 606, a second editable region 634C in the third coordinate space 606, and an edited data point 624C.

The first coordinate space 602 can include a third performance of a first feature 610C in a third state. The second coordinate space 604 can include a third performance of a second feature 620C in a third state. The third coordinate space 604 can include a third performance of a third feature 630B in a third state. The third state can correspond to a state of a performance of a feature corresponding to, for example, a base scenario including one or more modified values of one or more features via a user interface further to input received at the second state, and one or more further indications of editable regions permitting modification of one or more values of a feature via a user interface. The editable regions 614C, 624C and 634C can respectively indicate portions of the first, second, and third performances 610C, 620C and 630C that are editable via the user interface, and can be bounded by earlier time stamps at left window edges and later time stamps at right window edges thereof, for example. The editable regions 614C, 624C and 634C can respectively indicate portions of the first, second, and third performances 610C, 620C and 630C that are editable that differ from the bounds indicated by the editable regions 614B, 624B and 634B. The data points 612C, 622C and 632C can be editable via a user interface to have at least a value different than in the first state 600A or the second state 600B. The edited data point 624C can correspond to a data point that has been modified via a user interface and selected, saved, or the like, for example, as a modified value corresponding to the performance of the second feature.

FIG. 6D illustrates a fourth state of a user interface presentation to modify features of a model, further to the state of FIG. 6C. As illustrated by way of example in FIG. 6D, an example user interface presentation 600D can include the first coordinate space 602, the second coordinate space 604, the third coordinate space 606, a second set of edited data points 612D in the first coordinate space 602, and the edited data point 624C and a second set of edited data points 622D in the second coordinate space 604. The edited data points 612D and 622D can correspond to data points that have been modified via a user interface and selected, saved, or the like, for example, as a modified value corresponding to the performance of the first and second features, respectively.

The user interface presentation 600D can cease to present any editable regions upon saving, selecting, or the like, for example, of all of the edited data points. It is to be understood that the number of data points, the values of data points, the number of editable regions, the positions of editable regions, and the number of iterations of presentation of editable regions, at least, are not limited to the examples of 600A-D presented herein.

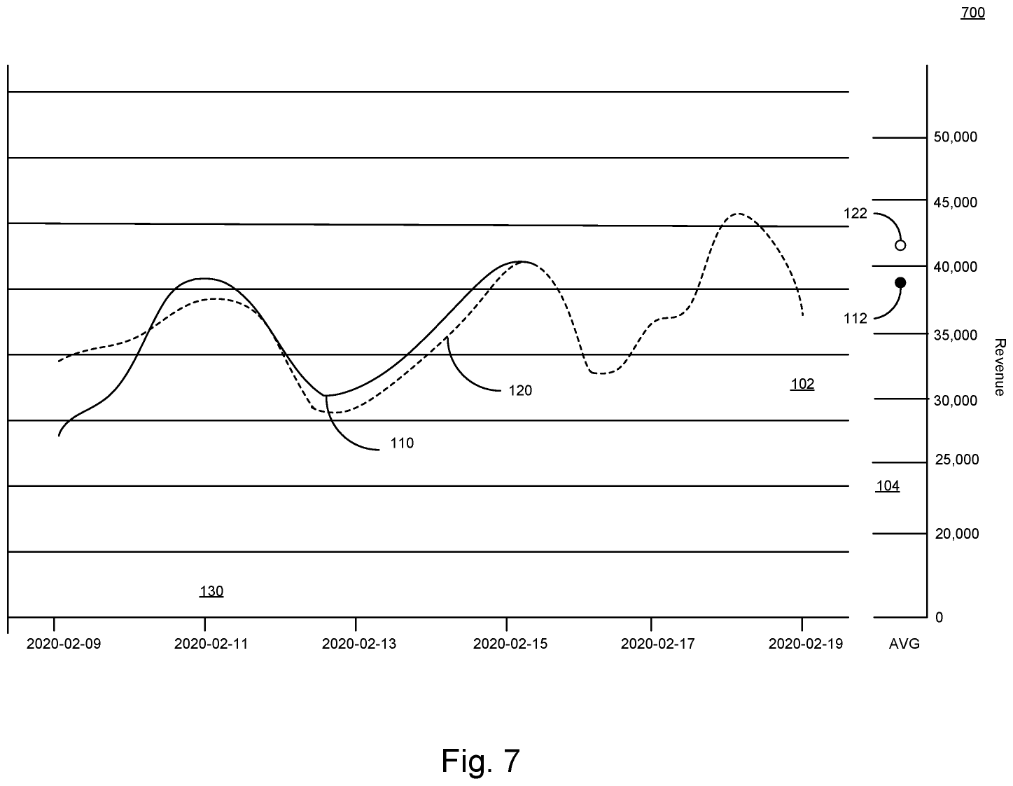

FIG. 7 illustrates a further user interface presentation of overlaid performance projections over time, in accordance with present implementations. As illustrated by way of example in FIG. 7, an example presentation 700 can include the first presentation area 102 and the second presentation area 104, the first performance 110, the second performance 120, the metric presentation region 140, the first metric 112 associated with the first performance 110, and the second metric associated with the second performance 120. As one example, the second performance can correspond to a performance of a model in view of the modifications to values made in accordance with the presentations of 600A-D.

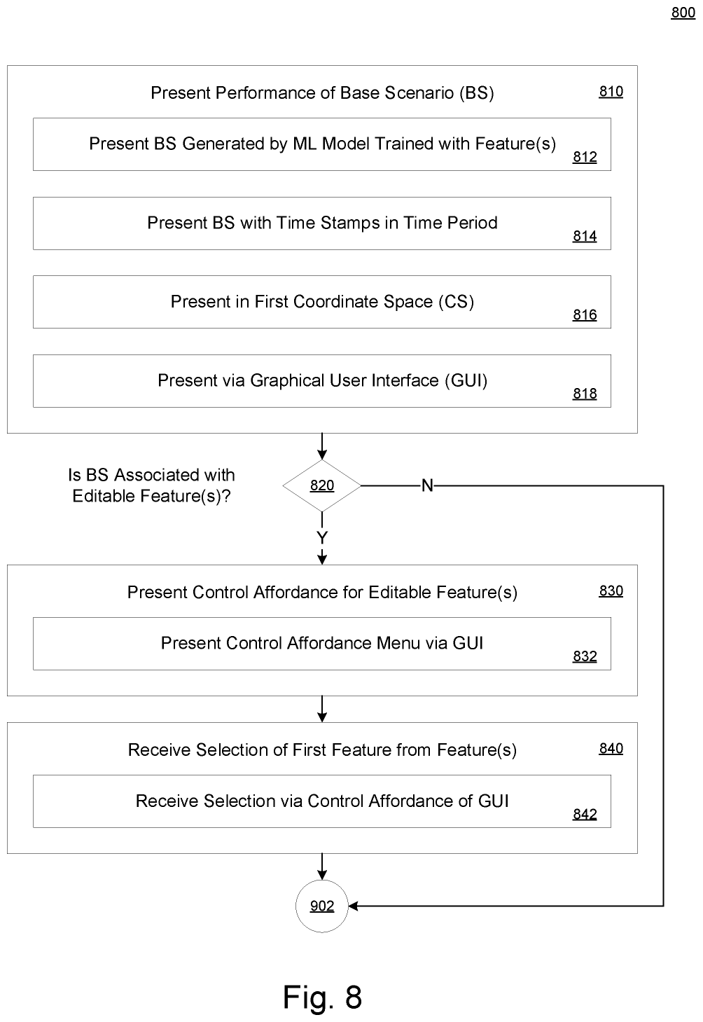

FIG. 8 illustrates a method of modifying a projection based on one more modified values of particular features in a model, in accordance with present implementations. At least one of the example systems 200 and 300 can perform method 800 according to present implementations. The method 800 can begin at step 810.

At step 810, the method can present a performance of a base scenario. Step 810 can include at least one of steps 812, 814, 816 and 818. At step 812, the method can present a performance of a base scenario generated by a machine learning model trained with one or more features. At step 814, the method can present a performance of a base scenario with time stamps in a time period. At step 816, the method can present the performance in a first coordinate space. As one example, a coordinate space can be a particular portion or area of a user interface presentation. At step 818, the method can present the performance via a graphical user interface. The graphical user interface can, for example, support one or more coordinate spaces in one or more user interface presentations. The method 800 can then continue to step 820.

At step 820, the method can determine whether the base scenario is associated with any editable features. As one example, the method can obtain one or more selection of features to be designated as editable via the user interface. In accordance with a determination that the base scenario is associated with editable features, the method 800 can continue to step 830. Alternatively, in accordance with a determination that the base scenario is not associated with any editable features, the method 800 can continue to step 902.

At step 830, the method can present at least one control affordance corresponding to the editable features. The control affordance can control one or more of selection and presentation of the editable features or any feature thereof, for example. Step 830 can include step 832. At step 832, the method can present a control affordance including a menu via a graphical user interface. The method 800 can then continue to step 840.

At step 840, the method can receive at least one selection of a first feature from among a plurality of features. As one example, the first feature can include an editable feature. Step 840 can include step 842. At step 842, the method can receive a selection via the control affordance of the graphical user interface. The method 800 can then continue to step 902.

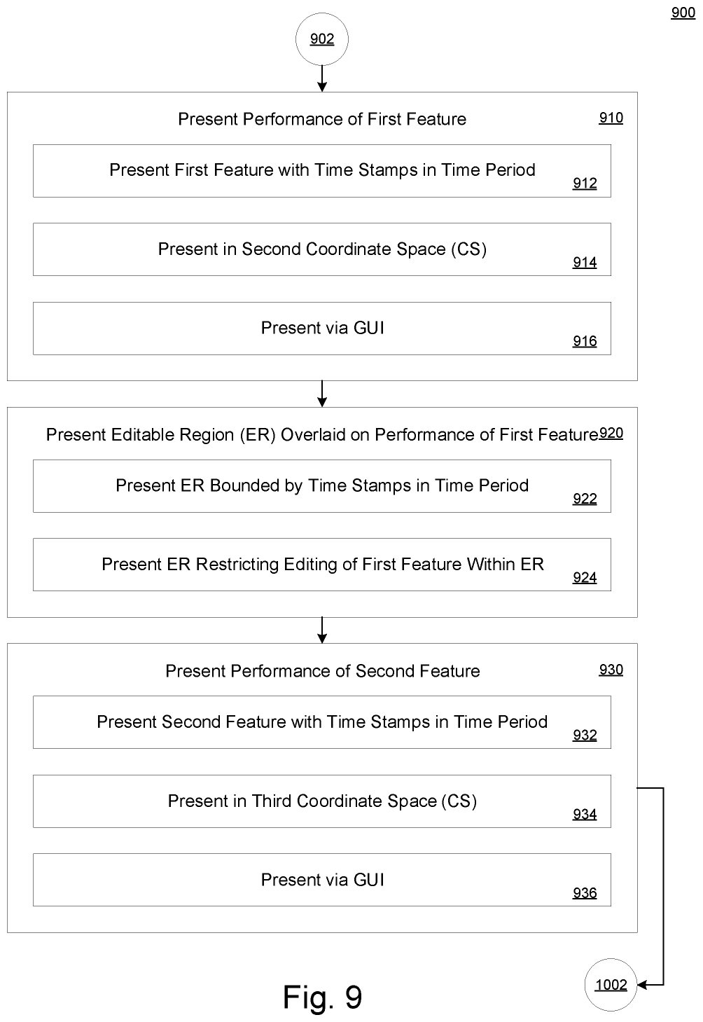

FIG. 9 illustrates a method of modifying a projection based on one more modified values of particular features in a model, further to the method of FIG. 8. At least one of the example systems 200 and 300 can perform method 900 according to present implementations. The method 900 can begin at step 902. The method 900 can then continue to step 910.

At step 910, the method can present a performance of a first feature. Step 910 can include at least one of steps 912, 914 and 916. At step 912, the method can present a performance of the first feature with time stamps in a time period. At step 914, the method can present the performance of the first feature in a second coordinate space. At step 916, the method can present the performance of the first feature via a graphical user interface. The method 900 can then continue to step 920.

At step 920, the method can present an editable region overlaid on the performance of a first feature. The editable region and indicate the portion or portions of the first feature that are editable via the user interface, for example. Step 920 can include at least one of steps 922 and 924. At step 922, the method can present an editable region bounded by one or more time stamps in the time period. As one example, the editable region can be bounded by a first earlier timestamp at 1:00 AM on a particular day, and can be bounded by a second later timestamps at 4:00 PM on the following day. At step 924, the method can present an editable region restricting editing of the first feature within the editable region. As one example, the values of the first feature can be editable only within the first earlier timestamp and the second later timestamp. The method 900 can then continue to step 930.

At step 930, the method can present a performance of a second feature. The second feature can be an editable feature distinct from the first feature, for example. Step 930 can include at least one of steps 932, 934 and 936. At step 932, the method can present a performance of the second feature with time stamps in a time period. At step 934, the method can present the performance in a third coordinate space. The third coordinate space can be presented concurrently with the second coordinate space. At step 936, the method can present the performance via a graphical user interface. The graphical user interface can present the second coordinate space concurrently with the third coordinate space in a common presentation. As one example, the second and third coordinate spaces can be presented as charts within a common GUI window. The method 900 can then continue to step 1002.

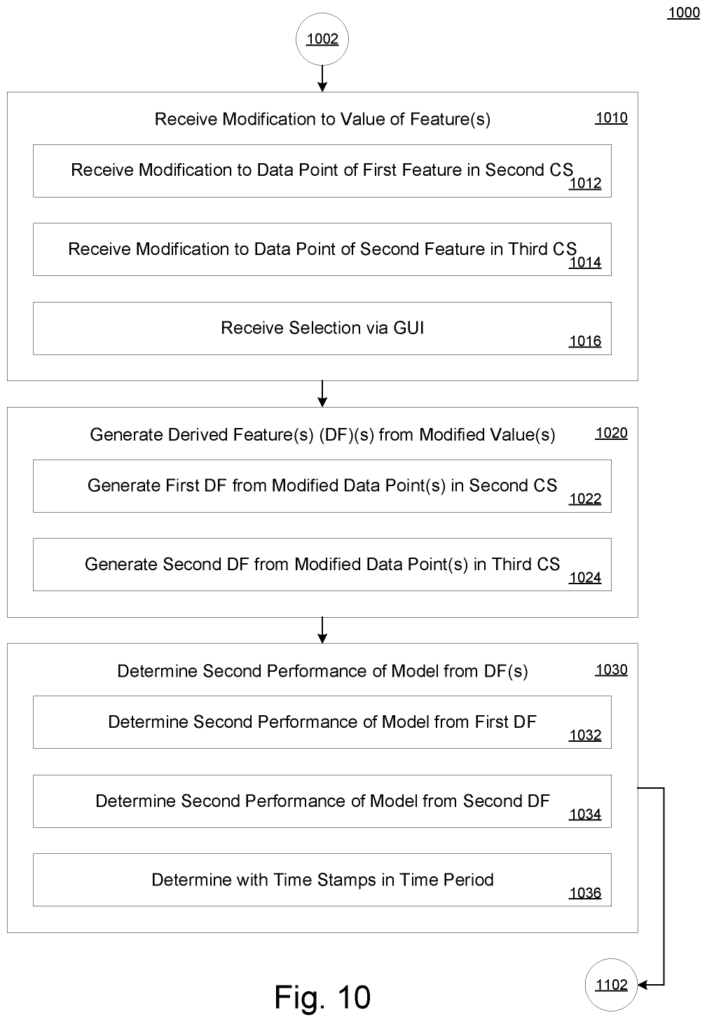

FIG. 10 illustrates a method of modifying a projection based on one more modified values of particular features in a model, further to the method of FIG. 9. At least one of the example systems 200 and 300 can perform method 1000 according to present implementations. The method 1000 can begin at step 1002. The method 1000 can then continue to step 1010.

At step 1010, the method can receive at least one modification to at least one value of at least one feature. Step 1010 can include at least one of steps 1012, 1014 and 1016. At step 1012, the method can receive a modification to a data point of a first feature in the second coordinate space. The data point can be a particular value of a feature associated with a particular entry, for example. At step 1014, the method can receive a modification to a data point of a second feature in the third coordinate space. At step 1016, the method can receive the modification by a selection via a graphical user interface. The election can, for example, include a “click-and-drag” The method 1000 can then continue to step 1020.

At step 1020, the method can generate one or more derived features based on the modified values. The derived features can include unmodified values from the features corresponding to the base scenario, and can include modified values from the features corresponding to a what-if scenario. The modified values can replace unmodified values having, for example, corresponding time stamps. Step 1020 can include at least one of steps 1022 and 1024. At step 1022, the method can generate a first derived feature from modified data points in the second coordinate space. At step 1024, the method can generate a second derived feature from modified data points in the third coordinate space. The method 1000 can then continue to step 1030.

At step 1030, the method can determine a second performance of a model based at least partially on one or more derived features. Step 1030 can include at least one of steps 1032, 1034 and 1036. At step 1032, the method can determine a second performance of a model from a first derived feature. At step 1034, the method can determine a second performance of a model from a second derived feature. The method can determine the second performance from one or more derived features, and as one example, can determine the second performance based on both the first and second derived features. It is to be understood that the method can determine a second performance from any number of derived features. It is to be further understood that present implementations are not limited to generating derived features based on derived features alone, and can include any number of editable or fixed features, or any combination thereof. At step 1036, the method can determine the second performance with time stamps in the time period. The second performance can then be compared to or comparable with the first performance with the time stamps and the time period. The method 1000 can then continue to step 1102.

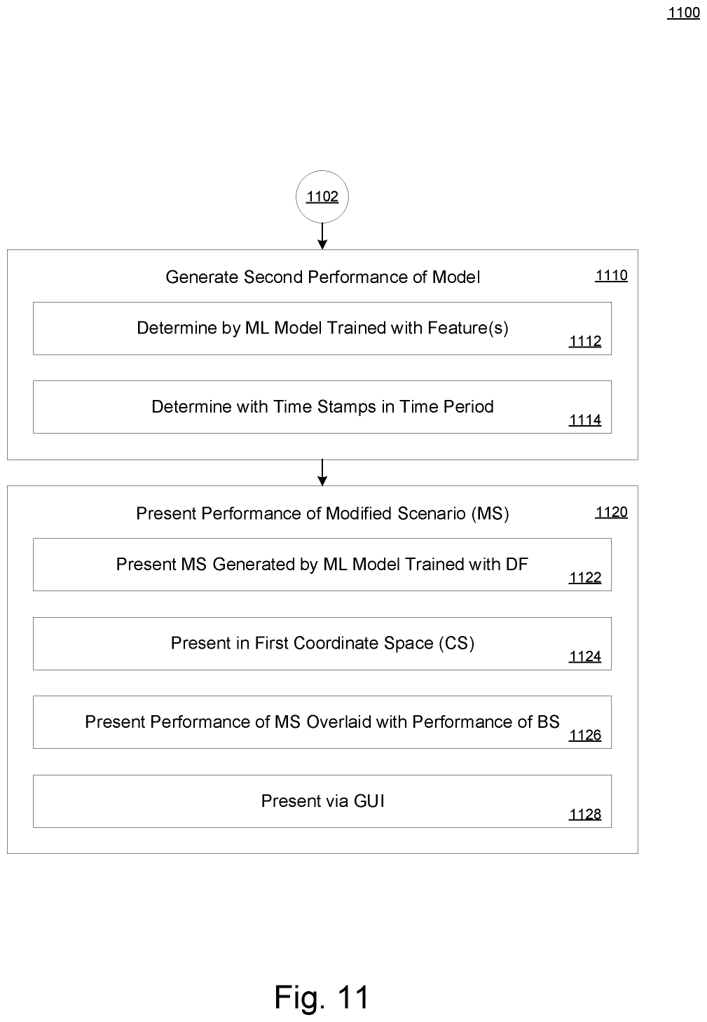

FIG. 11 illustrates a method of modifying a projection based on one more modified values of particular features in a model, further to the method of FIG. 10. At least one of the example systems 200 and 300 can perform method 1100 according to present implementations. The method 1100 can begin at step 1102. The method 1100 can then continue to step 1110.

At step 1110, the method can generate a second performance of the model. Step 1110 can include at least one of steps 1112 and 1114. At step 1112, the method can generate the second performance of the model based on the first derived feature. At step 1114, the method can generate the second performance of the model based on the second derived feature. The method 1100 can then continue to step 1120.

At step 1120, the method can present performance of a modified scenario. A modified scenario can correspond to a what-if scenario. Step 1120 can include at least one of steps 1122, 1124, 1126 and 1128. At step 1122, the method can present a modified scenario generated by an ML, model trained with one or more derived features. At step 1124, the method can present the performance of the modified scenario in the first coordinate space. At step 1126, the method can present the performance of the modified scenario overlaid with the performance of the base scenario. At step 1128, the method can present the performance of the modified scenario by a graphical user interface. The method 1100 can end at step 1120.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a data processing system comprising one or more processors, coupled to memory, to:
present, via a user interface, a first indication in a first coordinate space of a first performance generated by a model trained with a plurality of features using machine learning to output a plurality of data points having corresponding time stamps within a time period;
receive, via the user interface, a selection of a first feature of the plurality of features;
present, via the user interface, a second indication in a second coordinate space of a first performance of the first feature, the second indication having corresponding time stamps within the time period;
receive, via the user interface, a modification to a value in the second coordinate space of the first feature of the plurality of features;
generate, responsive to the modification in the second coordinate space, a first derived feature based on the modified value of the first feature;
determine a second performance of the model using machine learning based on the first derived feature to output derived data points having corresponding time stamps within the time period; and
present, via the user interface in the first coordinate space, a third indication of the second performance of the model overlaid with the first indication of the first performance of the model.

2. The system of claim 1, the data processing system further configured to:
determine whether one or more of the features are editable; and
present, in response to a determination that the features are editable, via the user interface, a control affordance corresponding to the features,
wherein the selection is received in response to user input at the control affordance.

3. The system of claim 1, wherein the control affordance comprises a menu including an item identifying the first feature.

4. The system of claim 1, the data processing system further configured to:
present, via the user interface, a first region in the second coordinate space, the first region bounded by a first time stamp in the time period and a second time stamp later than the first time stamp in the time period.

5. The system of claim 4, wherein the first region restricts editing of the data points of the first feature to data points having corresponding time stamps in the first region.

6. The system of claim 1, the data processing system further configured to:
present, via the user interface, a fourth indication within a third coordinate space, the fourth indication corresponding to a first performance of a second feature and including one or more data points having corresponding time stamps in the time period.

7. The system of claim 6, the data processing system further configured to:
generate the third indication with input including the first derived feature and a second derived feature to output the derived points, the second derived feature corresponding to a second performance of the second feature and including one or more data points having corresponding time stamps in the time period.

8. The system of claim 7, the data processing system further configured to:
receive, via the user interface, a selection of the second feature among the features;
receive, via the user interface, a modification to a second value in the third coordinate space of the second feature; and
generate, responsive to the modification in the third coordinate space, the second derived feature based on the modified value of the second feature.

9. The system of claim 8, the data processing system further configured to:
present, via the user interface, the second coordinate space and the fourth coordinate space concurrently within a graphical user interface presentation.

10. A method, comprising:
presenting, via a user interface, a first indication in a first coordinate space of a first performance generated by a model trained with a plurality of features using machine learning to output a plurality of data points having corresponding time stamps within a time period;
receiving, via the user interface, a selection of a first feature of the plurality of features;
presenting, via the user interface, a second indication in a second coordinate space of a first performance of the first feature, the second indication having corresponding time stamps within the time period;
receiving, via the user interface, a modification to a value in the second coordinate space of the first feature of the plurality of features;
generating, responsive to the modification in the second coordinate space, a first derived feature based on the modified value of the first feature;
determining a second performance of the model using machine learning based on the first derived feature to output derived data points having corresponding time stamps within the time period; and
presenting, via the user interface in the first coordinate space, a third indication of the second performance of the model overlaid with the first indication of the first performance of the model.

11. The method of claim 10, further comprising:
determining whether one or more of the features are editable; and
presenting, in response to a determination that the features are editable, via the user interface, a control affordance corresponding to the features,
wherein the selection is received in response to user input at the control affordance.

12. The method of claim 10, wherein the control affordance comprises a menu including an item identifying the first feature.

13. The method of claim 10, further comprising:
presenting, via the user interface, a first region in the second coordinate space, the first region bounded by a first time stamp in the time period and a second time stamp later than the first time stamp in the time period.

14. The method of claim 13, wherein the first region restricts editing of the data points of the first feature to data points having corresponding time stamps in the first region.

15. The method of claim 10, further comprising:
presenting, via the user interface, a fourth indication within a third coordinate space, the fourth indication corresponding to a first performance of a second feature and including one or more data points having corresponding time stamps in the time period.

16. The method of claim 15, further comprising:
generating the third indication with input including the first derived feature and a second derived feature to output the derived points, the second derived feature corresponding to a second performance of the second feature and including one or more data points having corresponding time stamps in the time period.

17. The method of claim 16, further comprising:
receiving, via the user interface, a selection of the second feature among the features;
receiving, via the user interface, a modification to a second value in the third coordinate space of the second feature; and
generating, responsive to the modification in the third coordinate space, the second derived feature based on the modified value of the second feature.

18. The method of claim 17, further comprising:
presenting, via the user interface, the second coordinate space and the fourth coordinate space concurrently within a graphical user interface presentation.

19. A computer readable medium including one or more instructions stored thereon and executable by a processor to:
present, by the processor and via a user interface, a first indication in a first coordinate space of a first performance generated by a model trained with a plurality of features using machine learning to output a plurality of data points having corresponding time stamps within a time period;
receive, by the processor and via the user interface, a selection of a first feature of the plurality of features;
present, by the processor and via the user interface, a second indication in a second coordinate space of a first performance of the first feature, the second indication having corresponding time stamps within the time period;
receive, by the processor and via the user interface, a modification to a value in the second coordinate space of the first feature of the plurality of features;
generate, by the processor and responsive to the modification in the second coordinate space, a first derived feature based on the modified value of the first feature;
determine, by the processor, a second performance of the model using machine learning based on the first derived feature to output derived data points having corresponding time stamps within the time period; and
present, by the processor and via the user interface in the first coordinate space, a third indication of the second performance of the model overlaid with the first indication of the first performance of the model.

20. The computer readable medium of claim 19, wherein the computer readable medium further includes one or more instructions executable by the processor to:
present, via the user interface, a fourth indication within a third coordinate space, the fourth indication corresponding to a first performance of a second feature and including one or more data points having corresponding time stamps in the time period.
